(19) United States
(12) Patent Application Publication
(10) Pub. No.: US 2025/0214306 A1
(43) Pub. Date: Jul. 3, 2025

(54) 3D PRINTING

(71) Applicant: Shenzhen Anker Smart Technology Co., Ltd, Shenzhen (CN)

(72) Inventor: Fan Wu, Shenzhen (CN)

(21) Appl. No.: 19/000,800

(22) Filed: Dec. 24, 2024

(30) Foreign Application Priority Data
Dec. 29, 2023 (CN) 202311864412.5

(51) Int. Cl. B29C 64/386; B29K 105/00; B33Y 10/00; B33Y 50/00; B33Y 70/00; B33Y 80/00

(52) U.S. Cl. CPC B29C 64/386; B33Y 10/00; B33Y 50/00; B33Y 70/00; B33Y 80/00; B29K 2105/0032

(57) ABSTRACT

Disclosed are a three-dimensional (3D) printed object and a method of printing the same. The method comprises determining whether an edge of the current base layer protrudes beyond an edge of a previous base layer. Based on determining that the edge of the current base layer does not protrude beyond the edge of the previous base layer, the method comprises printing a plurality of the current outer wall color layers in an edge region of a surface of an object and printing the current base layer in a middle region of the surface of the object to obtain an additively printed object. A thickness of the stacked current outer wall color layers equals a thickness of the current base layer

### CROSS-REFERENCE TO RELATED APPLICATION

The present disclosure claims priority of the Chinese Patent Application No. 202311864412.5, filed on Dec. 29, 2023 before the China National Intellectual Property Administration, entitled “3D Printing”, which is incorporated herein by reference in its entirety.

### FIELD

The present disclosure relates to the technical field of three-dimensional (3D) printing.

### BACKGROUND

3D printing technology, an additive manufacturing process, continues to evolve and mature, driving significant advancements in related manufacturing industries. The current 3D printing technology primarily employs fused deposition modeling (FDM) technology for layer-by-layer printing. However, this technology tends to produce 3D printed objects with low appearance precision and poor color reproduction.

### SUMMARY

In the present disclosure, 3D printed objects and methods of printing the 3D printed objects are provided to solve the problem that the 3D printed objects have low appearance precision and poor color reproduction.

To solve the above problem, a method of printing a 3D printed object is provided, comprising: obtaining (e.g., determining) a printing trajectory of a current outer wall color layer and a printing trajectory of a current base printing layer; determining whether an edge of the current base printing layer protrudes beyond an edge of a previous base printing layer; in response to determining that the edge of the current base printing layer does not protrude beyond the edge of the previous base printing layer, stackedly printing a plurality of the current outer wall color layers in an edge region of a printing surface of an object to be printed and printing the current base printing layer in a middle region of the printing surface of the object to be printed to obtain an additively printed object, in which a thickness of the stacked current outer wall color layers equals a thickness of the current base printing layer, and the edge region surrounds and adheres to the middle region; and regarding the additively printed object as a new object to be printed, and repeating the operation of determining whether the edge of the current base printing layer protrudes beyond the edge of the previous base printing layer and the subsequent operations until the 3D printed object is obtained.

In some examples, the stackedly printing a plurality of the current outer wall color layers in an edge region of a printing surface of an object to be printed and printing the current base printing layer in a middle region of the printing surface of the object to be printed to obtain an additively printed object comprises: stackedly printing a plurality of the current outer wall color layers in the edge region of the printing surface of the object to be printed until a thickness of the stacked current outer wall color layers reaches one-half of the thickness of the current base printing layer; printing the current base printing layer in the middle region of the printing surface of the object to be printed; and stackedly printing again a plurality of the current outer wall color layers on a side of the printed current outer wall color layers away from the printing surface until a thickness of the stacked current outer wall color layers reaches the thickness of the current base printing layer to obtain the additively printed object, wherein sides of the stacked current outer wall color layers close to the current base printing layer adhere to the current base printing layer.

In some examples, the stackedly printing a plurality of the current outer wall color layers in the edge region of the printing surface of the object to be printed and printing the current base printing layer in the middle region of the printing surface of the object to be printed to obtain the additively printed object comprises: stackedly printing a plurality of the current outer wall color layers in the edge region of the printing surface of the object to be printed until the thickness of the stacked current outer wall color layers reaches the thickness of the current base printing layer; and printing the current base printing layer by adhering to a plurality of the current outer wall color layers in the middle region of the printing surface of the object to be printed to obtain the additively printed object, wherein sides of the stacked current outer wall color layers close to the current base printing layer are flush.

In some examples, the stackedly printing a plurality of the current outer wall color layers in the edge region of the printing surface of the object to be printed and printing the current base printing layer in the middle region of the printing surface of the object to be printed to obtain the additively printed object further comprises: printing a current fixed color layer in an edge region of a current outer wall color layer on a side of the additively printed object away from the printing surface, wherein a side of the current fixed color layer close to the middle region protrudes beyond a side of the current outer wall color layer close to the middle region, such that the current fixed color layer adheres to a side of the current base printing layer away from the printing surface.

In some examples, the determining whether the edge of the current base printing layer protrudes beyond the edge of the previous base printing layer further comprises: in response to determining that the edge of the current base printing layer protrudes beyond the edge of the previous base printing layer, printing a current outer wall transmissive printing layer and the current fixed color layer alternately and stackedly in the edge region of the printing surface of the object to be printed, and printing the current base printing layer in the middle region of the printing surface of the object to be printed to obtain the additively printed object.

In some examples, the obtaining the object to be printed comprises: obtaining a printing trajectory of a bottom surface printing layer and printing the bottom surface printing layer based on the printing trajectory of the bottom surface printing layer; and printing a first end surface color layer on a side of the entire bottom surface printing layer to obtain the object to be printed.

In some examples, the regarding the additively printed object as a new object to be printed, and repeating the operation of determining whether the edge of the current base printing layer protrudes beyond the edge of the previous base printing layer and the subsequent operations until the 3D printed object is obtained further comprises: printing a second end surface color layer on a side of the entire additively printed object away from the bottom surface printing layer to obtain the 3D printed object.

In some examples, the obtaining the printing trajectory of the current outer wall color layer and the printing trajectory of the current base printing layer comprises: obtaining an overall shape of the 3D printed object; slicing the overall shape based on thicknesses of base printing layers to obtain printing trajectories of a plurality of layer structures of the 3D printed object; and retracting the printing trajectory of each of the layer structures by a preset distance, obtaining a printing trajectory of each of the base printing layers corresponding to the layer structures and obtaining a printing trajectory of each of color layers based on the retracted preset distance.

In some examples, the stackedly printing a plurality of the current outer wall color layers in the edge region of the printing surface of the object to be printed and printing the current base printing layer in the middle region of the printing surface of the object to be printed comprises: stackedly printing a plurality of the current outer wall color layers in the edge region of the printing surface of the object to be printed using photocuring ink, and printing the current base printing layer in the middle region of the printing surface of the object to be printed using fused deposition modeling (FDM) technology.

To solve the above problem, the present disclosure provides a three-dimensional (3D) printed object which is obtained by the method of printing a 3D printed object according to any one of the above, which comprises: a printing body including a plurality of base printing layers which are stacked and adhere to each other; and a color shell wrapping around an exposed side of the printing body and including a plurality of outer wall color layers which are stacked and adhere to each other, wherein the outer wall color layers and the base printing layers are stacked on a same horizontal plane, and a thickness of the outer wall color layer is less than a thickness of the base printing layer.

In some examples, the 3D printed object comprises one or more of a vertical sidewall, an inwardly sloping sidewall, and an overhanging sidewall, wherein sides away from the printing body of a plurality of the base printing layers corresponding to the vertical sidewall are flush, and sides away from the printing body of a plurality of the outer wall color layers corresponding to the vertical sidewall are flush; in a direction from a bottom surface to a top surface of the 3D printed object, edges, on the side away from the printing body, of a plurality of the base printing layers corresponding to the inwardly sloping sidewall are shortened layer by layer, and edges, on the side away from the printing body, of a plurality of the outer wall color layers corresponding to the inwardly sloping sidewall are inclined layer by layer to a side close to the printing body; and in a direction from the bottom surface to the top surface of the 3D printed object, edges, on the side away from the printing body, of a plurality of the base printing layers corresponding to the overhanging sidewall are lengthened layer by layer, and edges, on the side away from the printing body, of a plurality of the outer wall color layers corresponding to the overhanging sidewall are inclined layer by layer to the side away from the printing body.

In some examples, the 3D printed object further comprises a plurality of fixed color layers, wherein each of the fixed color layers and the outer wall color layers are stacked; a side of each of the fixed color layers close to the printing body protrudes beyond a side of the corresponding outer wall color layers close to the printing body; and a part of each of the fixed color layers, which is close to the printing body and protrudes beyond the corresponding outer wall color layers, is inserted into the printing body to adhere to two adjacent base printing layers.

In some examples, each of the base printing layers comprises a plurality of outer printing layers and an inner printing layer, and a thickness of each of the outer printing layers is less than a thickness of the inner printing layer.

In some examples, outer printing layers of a plurality of base printing layers corresponding to the overhanging sidewall are outer wall transmissive printing layers, and the outer wall transmissive printing layers extend toward a side away from the printing body until being exposed; and each of the fixed color layers is interposed between every two adjacent outer wall transmissive printing layers.

In some examples, the 3D printed object further comprises an end surface color layer and an end surface transmissive printing layer, wherein the printing body includes at least one end surface, and the end surface color layer adheres to the end surface, wherein the end surface includes a bottom surface, a bridging bottom surface, and a top surface; and when the end surface is the bottom surface or the bridging bottom surface, the end surface transmissive printing layer adheres to a side of the end surface color layer away from the printing body.

To solve the above problem, the 3D printed objected is obtained by the method including obtaining the printing trajectory of the current outer wall color layer and the printing trajectory of the current base printing layer; determining whether the edge of the current base printing layer protrudes beyond the edge of the previous base printing layer; in response to determining that the edge of the current base printing layer does not protrude beyond the edge of the previous base printing layer, stackedly printing a plurality of the current outer wall color layers in the edge region of the printing surface of the object to be printed and printing the current base printing layer in the middle region of the printing surface of the object to be printed to obtain the additively printed object; and regarding the additively printed object as the new object to be printed, and repeating the operation of determining whether the edge of the current base printing layer protrudes beyond the edge of the previous base printing layer and the subsequent operations until the 3D printed object is obtained. Precision of the outer wall color layer is higher than that of the base printing layer since the thickness of the outer wall color layer is less than the thickness of the base printing layer. By stacking a plurality of the outer wall color layers in the edge region, shape precision of the outermost part of the 3D printed object can be enhanced by using the outer wall color layers, thereby improving the appearance precision of the 3D printed object.

### BRIEF DESCRIPTION OF THE DRAWINGS

FIG. 1 is a flowchart of a method of printing a 3D printed object according to an example of the present disclosure;

FIG. 2 is a flowchart of a method of printing a 3D printed object according to another example of the present disclosure;

FIG. 3 is a schematic diagram of a cross-sectional structure of a 3D printed object according to an example of the present disclosure;

FIG. 4 is a schematic diagram of a structure of a base printing layer and a corresponding color layer according to an implementation;

FIG. 5 is a schematic diagram of a structure of a base printing layer and a corresponding color layer according to another implementation; and

FIG. 6 is a schematic diagram of a cross-sectional structure of a 3D printed object according to another example of the present disclosure.

### DETAILED DESCRIPTION

The technical solutions in the examples of the present disclosure will be clearly and completely described below in conjunction with the accompanying drawings in the examples of the present disclosure. It is clear that the examples described are merely a portion of the examples of the present disclosure, and not all of the examples. Based on the examples in the present disclosure, all other examples obtained by a person of ordinary skill in the art without making creative labor fall within the scope of protection of the present disclosure.

It should be noted that if the examples of the present disclosure involve a directional indication (such as up, down, left, right, forward, back, etc.), the directional indication is solely used to explain a relative positional relationship, a movement condition, etc., between components in a specific orientation (as shown in the drawings). If the specific orientation is changed, the directional indication is also changed accordingly.

Additionally, if there are descriptions involving “first,” “second,” etc., in the examples of the present disclosure, such descriptions are only for illustrative purposes and should not be understood as indicating or implying relative importance, nor do they implicitly specify the quantity of the indicated technical features. Thereby, a feature defined as “first,” “second,” etc. may expressly or implicitly include at least one such feature. Additionally, the technical solutions of the various examples may be combined with each other on the basis that such combinations can be implemented by a person of ordinary skill in the art. When a combination of technical solutions results in contradictions or cannot be implemented, such a combination should be considered non-existent and is not within the scope of protection of the present disclosure.

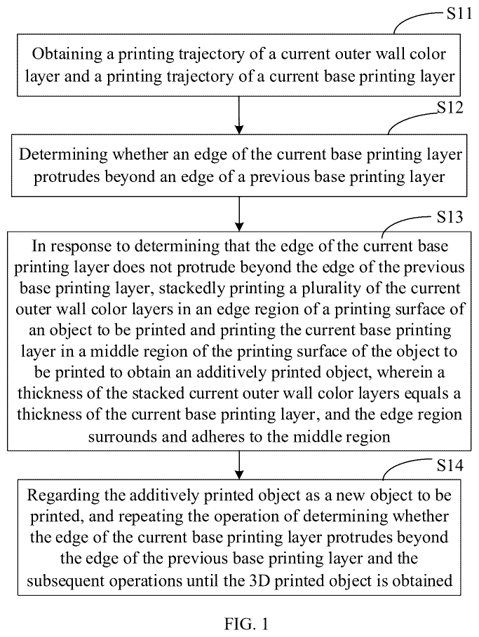

Referring to FIG. 1, FIG. 1 is a flowchart of a method of printing an object (e.g., a 3D printed object) according to an example of the present disclosure. The operations (e.g., methods) described herein may be performed by a computing device such as a printer comprising one or more processors and memory storing instructions that can be executed by the one or more processors.

Operation S11: a printing trajectory of a current outer wall color layer and a printing trajectory of a current base printing layer (e.g., a current base layer) are obtained. A layer may comprise a current base printing layer and a plurality of current outer wall color layers. An object to be printed refers to any intermediate product in a 3D printing process that still requires the base printing layer and the outer wall color layers to be printed thereon.

In a specific application scenario, the printing trajectories of the current outer wall color layers as well as the printing trajectory of the current base printing layer may be determined empirically based on slicing and segmentation of the appearance of the 3D printed object. In a specific application scenario, the printing trajectories of the current outer wall color layers and the printing trajectory of the current base printing layer may be determined and segmented based on the appearance of the 3D printed object using simulation software or a trained deep learning model. The specific method of obtaining these printing trajectories is not limited herein.

Operation S12: whether an edge of the current base printing layer protrudes beyond an edge of a previous base printing layer is determined. If the edge of the current base printing layer protrudes beyond the edge of the previous base printing layer (e.g., a length or width of current base printing layer is greater than a length or width of the previous base printing layer), this indicates that that the current base printing layer being printed forms an overhanging structure. If the edge of the current base layer does not protrude beyond the edge of the previous base layer, this indicates that the current base layer being printed forms a flush structure or an inwardly sloping structure.

Operation S13: in response to determining that the edge of the current base printing layer does not protrude beyond the edge of the previous base printing layer, an additively printed object is obtained by printing a plurality of the current outer wall color layers layer by layer in an edge region of a printing surface of an object to be printed and printing the current base printing layer in a middle region of the printing surface of the object to be printed. A thickness of the stacked current outer wall color layers may equal a thickness of the current base printing layer, and the edge region may surround and adhere to (e.g., stick firmly, attach to) the middle region.

If the edge of the current base printing layer does not protrude beyond the edge of the previous base printing layer, there is foundational support for the printing of the outer wall color layers, and the additively printed object is obtained by printing a plurality of the current outer wall color layers layer by layer in the edge region of the printing surface of the object to be printed and printing the current base printing layer in the middle region of the printing surface of the object to be printed. A thickness of the stacked current outer wall color layers equals a thickness of the current base printing layer, and the edge region surrounds and adheres to the middle region. The edge region surrounds and adheres to the middle region, and the current outer wall color layers also surround and adhere to the current base printing layer.

In a specific application scenario, the current base printing layer may be printed by a fused filament fabrication (FDM) technology. In a specific application scenario, the current base printing layer may be printed by a printing technology such as resin 3D printing technology, a powder bed fusion (PBF) printing technology, a material jetting (M-Jet) printing technology, or an Arburg plastic freeforming (APF) printing technology, which is not limited herein.

In a specific application scenario, the current color layers may be printed by a full-color inkjet photocuring 3D printing technology. In a specific application scenario, the current color layers may be printed by a thermosetting ink printing technology, an ink printing technology using a curing agent, or other ink printing technologies that involve chemical curing.

The thickness of the stacked current outer wall color layers may be equal to the thickness of the current base printing layer, indicating that a thickness of an outer wall color layer is less than the thickness of the base printing layer, so that the precision as well as the resolution of the outer wall color layer is higher than those of the base printing layer. By stacking a plurality of the outer wall color layers in the edge region, the shape precision of an outermost part of the 3D printed object is enhanced, thereby improving the appearance precision of the 3D printed object.

Operation S14: the additively printed object is regarded (e.g., determined) as a new object to be printed, and the operation of determining whether the edge of the current base printing layer protrudes beyond the edge of the previous base printing layer and the subsequent operations are repeated until the 3D printed object is obtained.

In a specific application scenario, after the additively printed object is obtained by adding one base printing layer and a plurality of the outer wall color layers to the object to be printed, if further printing is needed, the additively printed object is regarded as the new object to be printed, and the operations S11-S13 are repeated until all layers are printed, resulting in the 3D printed object.

In a specific application scenario, after the additively printed object is obtained by adding one base printing layer and a plurality of the outer wall color layers to the object to be printed, if printing is complete, the additively printed object is regarded as the 3D printed object, and printing is terminated.

In this example, through the above operations of obtaining the printing trajectories of the current outer wall color layers and the printing trajectory of the current base printing layer; determining whether the edge of the current base printing layer protrudes beyond the edge of the previous base printing layer; in response to determining that the edge of the current base printing layer does not protrude beyond the edge of the previous base printing layer, printing a plurality of the current outer wall color layers layer by layer in the edge region of the printing surface of the object to be printed and printing the current base printing layer in the middle region of the printing surface of the object to be printed to obtain the additively printed object; and regarding the additively printed object as the new object to be printed, and repeating the operation of determining whether the edge of the current base printing layer protrudes beyond the edge of the previous base printing layer and the subsequent operations until the 3D printed object is obtained, the precision as well as the resolution of the outer wall color layer is higher than those of the base printing layer since the thickness of the outer wall color layer is less than the thickness of the base printing layer. By stacking a plurality of the outer wall color layers in the edge region, the shape precision and color precision of the outermost part of the 3D printed object are enhanced by using the outer wall color layers, thereby improving the appearance precision and color precision of the 3D printed object.

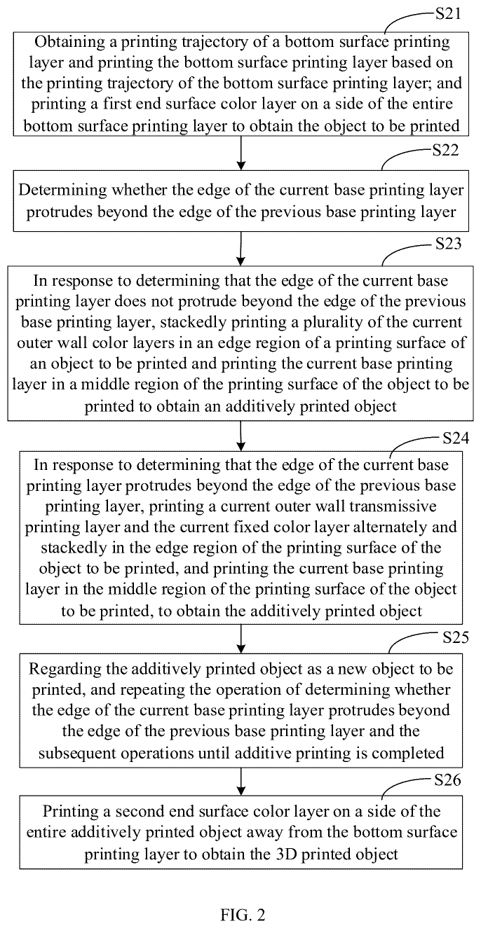

Referring to FIG. 2, FIG. 2 is a flowchart of a method of printing a 3D printed object according to another example of the present disclosure.

Operation S21: a printing trajectory of a bottom surface printing layer is obtained and the bottom surface printing layer is printed based on the printing trajectory of the bottom surface printing layer; and the object to be printed is obtained by printing a first end surface color layer on a side of the entire bottom surface printing layer.

In this example, the printing of an entire 3D printed object is divided into stacked printing of layer structures. For example, the 3D printed object is obtained by stacking these layer structures through stacked printing. In a specific application scenario, if the entire 3D printed object may be divided into layer structures of 10 layers for printing, a printing process involves sequentially printing the layer structures of the first layer, the second layer, the third layer, and so on up to the tenth layer. By stacking these layer structures of 10 layers, the final 3D printed object is obtained.

In an example, an overall shape of the 3D printed object is obtained. The overall shape is sliced based on a thickness of a base printing layer to obtain printing trajectories of a plurality of layer structures of the 3D printed object. A layer structure includes a single base printing layer and a plurality of color layers provided in the same layer as the base printing layer.

After obtaining the printing trajectories of a plurality of the layer structures of the 3D printed object, the printing trajectories of the layer structures are then retracted by a preset distance. A printing trajectory of each of the base printing layers corresponding to the layer structures is obtained, and a printing trajectory of the corresponding color layers corresponding to the layer structures are obtained based on the retracting preset distance. That is, the printing trajectories of the layer structures are divided into the printing trajectories of the base printing layers and the printing trajectories of the color layers based on the preset distance.

The preset distance may be in a range of 0.2 mm to 0.5 mm, such as 0.2 mm, 0.3 mm, 0.4 mm, or 0.5 mm.

In a specific application scenario, assuming that a 3D printed object is a cylinder with a diameter of 5 mm, a printing trajectory of a certain layer structure is a circle with a diameter of 5 mm. If a preset distance is 0.3 mm, a printing trajectory of a base printing layer of the layer structure is a circle with a diameter of 4.7 mm, and the printing trajectory of a plurality of color layers corresponding to the layer structure is a circular ring with a ring width of 0.3 mm. This application scenario is intended for illustrative purposes only and does not limit any shape described therein.

In this example, the printing trajectory of each layer structure is retracted (e.g., adjusted) by the preset distance, meaning that all exposed sides of the 3D printed object in that layer structure are retracted by the preset distance. That is, an outer surface of each layer structure is retracted, and if there is a hollow structure, an outer surface of the hollow structure is also retracted by the preset distance. For example, if a 3D printed object is a ring with a ring width of 5 mm, inner and outer surfaces of the ring are retracted by 0.3 mm, respectively, resulting in a printing trajectory of a base printing layer with a ring width of 4.4 mm and a printing trajectory of two color layers with a ring width of 0.3 mm.

Slicing processing may be carried out through slicing software. When the FDM technology is used for printing the base printing layers, an FDM slicing algorithm may be employed to slice the overall shape of the 3D printed object, thereby obtaining the printing trajectories of the layer structures. When other printing technologies are used for printing the base printing layers, appropriate slicing software or models may be correspondingly used for slice processing.

In this operation, when starting to print the 3D printed object, the printing begins with the bottom surface printing layer to create a base. Specifically, the printing trajectory of the bottom surface printing layer is obtained, the bottom surface printing layer is printed based on the printing trajectory of the bottom surface printing layer, and the first end surface color layer is provided on a side of the bottom surface printing layer close to the printing body.

Since the bottom surface of the 3D printed object also requires color display but is often in contact with other objects, directly applying a color layer may lead to color peeling. To address this, in an example, the bottom surface printing layer is provided, and then the first end surface color layer is provided on the entire bottom surface printing layer. The bottom surface printing layer serves to protect the first end surface color layer, enhancing the structural stability of the first end surface color.

In a specific application scenario, in order to facilitate the transmission of the color of the first end surface color layer, the bottom surface printing layer may be configured as a transmissive printing layer, so as to allow the first end surface color layer of the bottom surface to be displayed through the transmissive printing layer. By covering the bottom surface printing layer on an outer side of the first end surface color layer, the first end surface color layer can be prevented from being exposed, thereby improving the structural stability of the first end surface color layer.

To ensure the transparency of the bottom surface printing layer, a thickness of the bottom surface printing layer may be less than that of the base printing layer. Specifically, a thin and transparent bottom surface printing layer is printed first, a line width of a nozzle is reduced, the ironing mode is turned on, the nozzle is gently moved over a printing surface in a manner that extrudes little or no material, and heat and pressure are used to melt and flatten small particles and irregularities on the surface. This process reduces or eliminates the layered texture that occurs during printing, resulting in a smoother surface. The purpose of ironing is to improve the smoothness and appearance of the printed surface. Subsequently, the first end surface color layer is printed on the entire bottom surface printing layer. At this time, without directly curing the first end surface color layer, light curing is applied to the first end surface color layer through the basic printing layer after the basic printing layer in a first layer is printed on the first end surface color layer, which ensures the saturation of color and the interlayer binding force between the bottom surface printing layer and the base printing layer.

Operation S22: whether an edge of the current base printing layer protrudes beyond an edge of a previous base printing layer is determined.

A sidewall of the 3D printed object includes one or more of a vertical sidewall, an inwardly sloping sidewall, and an overhanging sidewall. If the current base printing layer protrudes beyond the previous base printing layer, this indicates that that the overhanging sidewall is being formed. If the current base printing layer does not protrude beyond the previous base printing layer, this indicates that the vertical or inwardly sloping sidewall is being formed.

Operation S23: in response to determining that the edge of the current base printing layer does not protrude beyond the edge of the previous base printing layer, an additively printed object is obtained by printing a plurality of the current outer wall color layers layer by layer in an edge region of a printing surface of an object to be printed and printing the current base printing layer in a middle region of the printing surface of the object to be printed.

If the edge of the current base printing layer does not protrude beyond the edge of the previous base printing layer, this indicates that the vertical or inwardly sloping sidewall is being formed. In this case, there is foundational support for stacked printing of the color layers, and at least two printing methods below can be used for printing the layer structures.

The first printing method for the vertical sidewall or inwardly sloping sidewall comprises: printing a plurality of current outer wall color layers (e.g., a first subset of plurality of current outer wall color layers) layer by layer in the edge region of the printing surface of the object to be printed until a thickness of the stacked current outer wall color layers reaches one-half of the thickness of the current base printing layer; printing the current base printing layer in the middle region of the printing surface of the object to be printed; and printing again a plurality of current outer wall color layers (e.g., a second subset of plurality of current outer wall color layers) layer by layer on a side, away from the printing surface, of the current outer wall color layers that have been printed until a thickness of the stacked current outer wall color layers reaches the thickness of the current base printing layer to obtain the additively printed object. Sides of the stacked current outer wall color layers close to the current base printing layer adhere to the current base printing layer. The outer wall color layers may be closely adjacent to the outer wall layer and are on the outside of the outer wall layer, wrapping around the outer wall layer.

Since the shape of the prepared current base printing layer may sometimes be circular arc-shaped, the printing trajectories of the outer wall color layers may be adjusted according to a curvature of the base printing layer to allow for a certain extension, making the base printing layer adhering to the corresponding outer wall color layers in the same layer as the base printing layer. By printing the outer wall color layers in multiple stages, the printing of the outer wall color layers and the printing of the base printing layer do not interfere with each other or block each other, making the base printing layer adhering to the corresponding outer wall color layers.

The second printing method for the vertical sidewall or the inwardly sloping sidewall comprises: printing a plurality of the current outer wall color layers layer by layer in the edge region of the printing surface of the object to be printed until the thickness of the stacked current outer wall color layers reaches the thickness of the current base printing layer; and in the middle region of the printing surface of the object to be printed, printing the current base printing layer by adhering to a plurality of the current outer wall color layers to obtain the additively printed object. Sides of the stacked current outer wall color layers close to the current base printing layer are flush. Thereby, the outer wall color layers in the same layer as the current base printing layer are printed coherently, and the printing efficiency of the outer wall color layers is improved.

In a specific application scenario, after obtaining the additively printed object, a current fixed color layer is printed in an edge region of a current outer wall color layer on a side of the additively printed object away from the printing surface, wherein a side of the current fixed color layer close to the middle region protrudes beyond a side of the current outer wall color layer close to the middle region, such that the current fixed color layer adheres to a side of the current base printing layer away from the printing surface. To enable the fixed color layer to adhere to the current base printing layer, the friction area between the fixed color layer and the current base printing layer is increased, thereby increasing the binding force between the fixed color layer and the current base printing layer, and further improving the binding force between the entire color layer and the base printing layer. The fixed color layer and the outer wall color layer, made of the same material, are stacked on and adhere to each other, the binding force between the entire color layer and the base printing layer can be improved by increasing the binding force between the fixed color layer and the base printing layer.

Operation S24: in response to determining that the edge of the current base printing layer protrudes beyond the edge of the previous base printing layer, a current outer wall transmissive printing layer and a current fixed color layer are printed alternately and layer by layer in the edge region of the printing surface of the object to be printed, and the current base printing layer is printed in the middle region of the printing surface of the object to be printed to obtain the additively printed object.

If the edge of the current base printing layer protrudes beyond the edge of the previous base printing layer, this indicates that the overhanging sidewall is being formed. At this time, because there is no foundational support for the stacked printing of the color layers, the following printing method may be used. The printing method includes: printing the current outer wall transmissive printing layer and the current fixed color layer alternately and layer by layer in the edge region of the printing surface of the object to be printed, and printing the current base printing layer in the middle region of the printing surface of the object to be printed to obtain the additively printed object.

By configuring an edge region of the base printing layer corresponding to the overhanging side wall as a transmissive printing layer, the appearance shape of this part of the 3D printed object in the portion is presented. By inserting the fixed color layer between adjacent outer wall transmissive printing layers, the color of the fixed color layer is allowed to transmit through the outer wall transmissive printing layers under the transmissive property of the outer wall transmissive printing layers, thereby ensuring the appearance color of this part of the 3D printed object in that part.

In a specific application scenario, a thickness of an outer wall transmissive printing layer may be less than the thickness of the base printing layer, which can increase the precision as well as the resolution of the transmissive printing layer, and thus improve the appearance precision of the 3D printed object.

The vertical sidewall, the inwardly sloping sidewall, and the overhanging sidewall of the 3D printed object may be printed by the printing methods described above, so as to combine the 3D printed object having any appearance shape. In this example, the different printing methods for the different sidewalls can improve the success rate of printing the different sidewalls.

Operation S25: the additively printed object is regarded as a new object to be printed, and the operation of determining whether the edge of the current base printing layer protrudes beyond the edge of the previous base printing layer and the subsequent operations are repeated until additive printing is completed.

In a specific application scenario, if one base printing layer and one color layer have been added to the object to be printed, if further printing is needed, the additively printed object is regarded as the new object to be printed, and the above operations S22-S24 are repeated until all layers are printed, resulting in the final 3D printed object.

In a specific application scenario, if one base printing layer and one color layer have been added to the object to be printed, if printing is complete, operation S25 is to be performed.

Operation S26: the 3D printed object is obtained by printing a second end surface color layer on a side of the entire additively printed object away from the bottom surface printing layer.

In a specific application scenario where a top surface of the 3D printed object needs to be printed, a top surface printing layer needs to be printed at last, and a second end surface color layer is printed on a side of the entire additively printed object away from the bottom surface printing layer to cover this end surface for display appearance color. If necessary, a printing trajectory of the top surface printing layer may be obtained, and based on the printing trajectory of the top surface printing layer, the top surface printing layer may be printed on a side of the second end surface color layer that is away from the additively printed object.

Without directing cuing the printed second end surface color layer, the top surface printing layer may be printed directly on the second end surface color layer, a line width of a nozzle is reduced, the ironing mode is turned on to ensure that top surface printing layer is flat and fine, and then the second end surface color layer is photocured through the top surface printing layer, so as to improve the interlayer binding force between the top surface printing layer and the second end surface printing object.

In this example, the top surface printing layer and the bottom surface printing layer are both transmissive printing layers, i.e., in order to facilitate the transmission of the color of the top color layer, the top surface printing layer may be configured as a transmissive printing layer, so as to enable the color of the second end surface color layer on the top surface to be transmitted and displayed through the transparent top surface printing layer. By covering the top surface printing layer on an outer side of the end surface color layer, the second end surface color layer can be prevented from being exposed, and thus the structural stability of the second end surface color layer can be improved.

In some examples, the base printing layer may be printed by using the FDM technology, and the color layer may be printed based on a photocurable ink. That is, a plurality of base printing layers of the printing body may be printed layer by layer by the FDM technology, thereby improving the printing efficiency of the printing body. The color layers of a color shell may be printed layer by layer by using the full-color inkjet photocuring 3D printing technology, thereby improving the precision as well as the color fineness of the color layers. Full-color inkjet photocuring 3D printing involves using a traditional inkjet nozzle to jet photocurable ink, which is then exposed to UV light to cure the ink, spraying the photocurable ink onto a cured layer according to a printing trajectory, curing the ink again, and printing layer by layer until the model is complete. The photocurable ink may include cyan ink, magenta ink, yellow ink, black ink, white ink, and/or transparent ink. The white or transparent ink adapts to a variety of color needs. In this example, the printing body of the 3D printed object is prepared by the FDM technology, which uses FDM filaments to replace the more expensive photosensitive ink or white ink material, so as to reduce the cost of the 3D printed object.

Through the above operations of retracting the printing trajectories of a plurality of the layer structures of the 3D printed object by the preset distance, and obtaining the printing trajectory of each of the base printing layers, and the printing trajectory of each of color layers to print the base printing layers and outer wall printing layers. Thus, the shape precision of the outermost part of the 3D printed object is enhanced by using the more refined color layers, thereby improving the appearance precision of the 3D printed object. Moreover, a more delicate and realistic color expression can be achieved using the high-precision color layers, enhancing the color presentation accuracy and color reproduction of the 3D printed object. A fixed color layer is inserted between every two adjacent base printing layers. By enhancing the binding force between the fixed color layer and the base printing layers, the overall binding force between the color shell and the base printing layers is improved, thereby increasing the structural stability and reliability of the 3D printed body. The edge regions of a plurality of the base printing layers corresponding to the overhanging sidewall are configured as the transmissive printing layers, thus presenting the appearance shape of this part of the 3D printed object. By inserting the fixed color layer between the adjacent transmissive printing layers and utilizing the transparent nature of the transmissive printing layers, the color of the fixed color layer is transmitted, thereby ensuring the appearance color of this part of the 3D printed object. In order to ensure the color of the end surfaces of the 3D printed object, by providing the end surface color layers at the end surfaces, which cover the entire end surfaces, respectively, and providing the end surface transmissive printing layer at a side of each end surface color layer away from the printing body, the colors of the end surfaces are displayed through the transmissive printing layers. By covering the outer side of the end surface color layer with the transmissive printing layer, the end surface color layer can be prevented from exposure, thereby enhancing the structural stability of the end surface color layer.

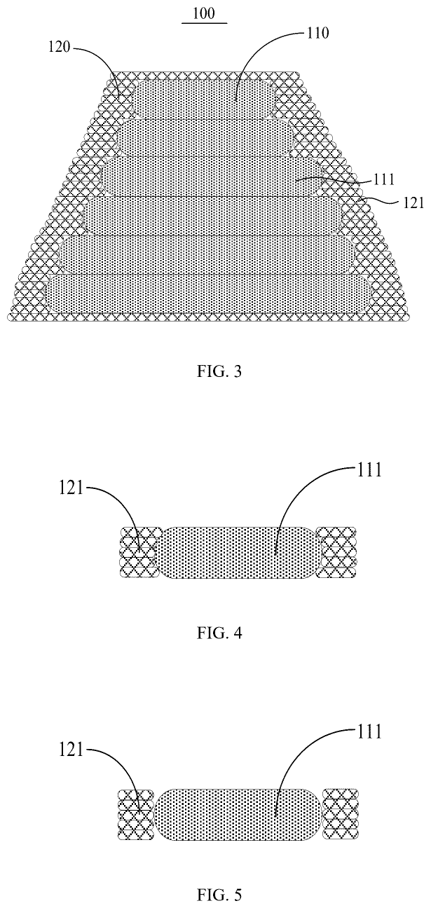

Referring to FIG. 3, FIG. 3 is a schematic diagram of a cross-sectional structure of a 3D printed object according to an example of the present disclosure. The 3D printed object of this example is completed by the method of printing the 3D printed object described herein.

The 3D printed object 100 comprises a printing body 110 and a color shell 120. The printing body 110 is a printing structure of a body of the 3D printed object 100. A shape of the printing body 110 may be designed based on actual needs of the 3D printed object 100, including but not limited to: a cube, a cylinder, a cone, a frustum, a humanoid 3D structure, an animal 3D structure, or an irregular 3D structure, etc. The printing body 110 is used to support the appearance shape of the 3D printed object 100. The color shell 120 is an outermost color structure of the 3D printed object 100 and used to reflect the appearance color of the 3D printed object 100. The color shell 120 may be provided on an outermost side of the 3D printed object 100 and can smooth the appearance of the 3D printed object 100.

The printing body 110 comprises a plurality of base printing layers 111 that are stacked on and adhere to each other. The printing body 110 is formed by stacking a plurality of the base printing layers 111, and the color shell 120 wraps around an exposed side of the printing body 110 so that the outermost appearance shape as well as the color of the 3D printed object 100 are directly presented by the color shell 120.

The color shell 120 comprises a plurality of outer wall color layers 121 that are stacked on and adhere to each other. The outer wall color layers 121 and the base printing layers 111 may be stacked relative to the same horizontal plane. A thickness of an outer wall color layer 121 may be less than a thickness of a base printing layer 111.

Since the thickness of the outer wall color layer 121 is less than the thickness of the base printing layer 111, the precision and resolution of the outer wall color layer 121 are higher than those of the base printing layer 111. By stacking a plurality of the outer wall color layers 121 and making them wrap around the exposed side of the printing body 110, the shape precision of the outermost part of the 3D printed object 100 is enhanced, thereby improving the appearance precision of the 3D printed object 100. A base printing layer 111 may correspond to a plurality of outer wall color layers 121 (e.g., 5 outer wall color layers 121). A thickness of a base printing layer 111 may be the same or substantially same of a thickness of a plurality of outer wall color layers 121.

A plurality of the outer wall color layers 121 are provided on the exposed side of the 3D printed object 100, and a more delicate and realistic color expression can be achieved using the high-precision outer wall color layers 121, thereby improving the color presentation accuracy and color reproduction of the 3D printed object 100.

Through the above operations, the 3D printed object of this example includes the printing body including a plurality of the base printing layers stacked on and adhering to each other as well as the color shell including a plurality of the color layers stacked on and adhering to each other. The color shell wraps around the exposed side of the printing body, the color layers and the base printing layer are stacked on the same horizontal plane, and the thickness of the color layer is less than the thickness of the base printing layer, thereby enhancing the shape accuracy of the outermost side of the 3D printed object and improving the appearance precision of the 3D printed object by utilizing a more refined color layer. Moreover, a more delicate and realistic color expression can be achieved using the high-precision color layers, enhancing the color presentation accuracy and color reproduction of the 3D printed object.

In some examples, a plurality of the base printing layers 111 of the printing body 110 may be printed layer by layer by the FDM technology, thereby increasing the printing efficiency of the printing body 110. The outer wall color layers 121 of the color shell 120 may be printed layer by layer by the full-color inkjet photocuring 3D printing technology, thereby improving the precision as well as the color fineness of the outer wall color layers 121. Full-color inkjet photocuring 3D printing involves using a traditional inkjet nozzle to jet photocurable ink, which is then exposed to UV light to cure the ink, spraying the photocurable ink onto a cured layer according to a printing trajectory, curing the ink again, and printing layer by layer until the model is complete. The photocurable ink may include cyan ink, magenta ink, yellow ink, black ink, white ink, and/or transparent ink. The white or transparent ink adapts to a variety of color needs.

In some examples, a plurality of the base printing layers 111 of the printing body 110 may be printed by a high-efficiency printing technology such as a resin 3D printing technology, a powder bed fusion (PBF) printing technology, a material jetting (M-Jet) printing technology, or an Arburg plastic freeforming (APF) printing technology. The outer wall color layers 121 of the color shell 120 may be printed by a high-precision ink printing technology such as a thermosetting ink printing technology or an ink printing technology using a curing agent, which is not limited herein.

In some examples, a plurality of the outer wall color layers 121 provided in the same layer as the base printing layer 111 all adhere to (e.g., attach to) the base printing layer 111. The outer wall color layers 121 adhere to the base printing layer 111, which can improve the binding force between the outer wall color layers 121 and the base printing layer 111, and improve the structural stability between the color shell 120 and the printing body 110.

In a specific application scenario, the shape of the prepared base printing layer 111 may sometimes be circular arc-shaped, and the printing trajectories of the outer wall color layers 121 may be adjusted according to a curvature of the base printing layer 111 to allow for a certain extension, thereby making the base printing layer 111 adhering to the corresponding outer wall color layers 121 in the same layer as the base printing layer, and further improving the close binding between the outer wall color layers 121 and the base printing layer 111. In other application scenarios, the shape of the prepared base printing layer 111 may be oblique, concave, vertical, and the like, which is determined based on the actual needs, and not limited herein.

Referring to FIG. 4, FIG. 4 is a schematic diagram of a structure of a base printing layer and a corresponding color layer according to an implementation.

In this implementation, a base printing layer 111 adheres to outer wall color layers 121 provided in the same layer as the base printing layer 111. The color layers may be slightly adjusted to extend along a curvature of the base printing layer 111, making it adhere to the base printing layer 111, thereby improving a tight binding force between the outer wall color layers 121 and the base printing layer 111.

In some examples, the outer wall color layers 121, which are provided in a same layer as the base printing layer 111, are flush at a side close to the base printing layer 111. The outer wall color layers 121 that are flush can be printed continuously without considering a printing condition of the base printing layer 111 that is provided in the same layer, thereby improving the printing efficiency of the color shell 120.

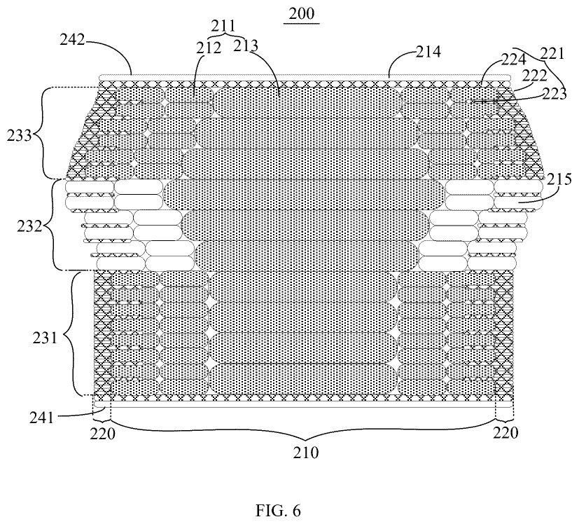

Referring to FIG. 5, FIG. 5 is a schematic diagram of a structure of a base printing layer and a corresponding color layer according to another implementation.

In this implementation, a plurality of outer wall color layers 121, which are provided in a same layer as the base printing layer 111, are flush at both sides. The outer wall color layers 121 that are flush can be printed continuously without considering a printing condition of the base printing layer 111 that is provided in the same layer, thereby improving the printing efficiency of the color shell 120.

Referring to FIG. 6, FIG. 6 is a schematic diagram of a cross-sectional structure of a 3D printed object according to another example of the present disclosure.

The wrapping relationship between the printing body 210 and the color shell 220 and the printing method may be the same as those described in the previous examples, which can be referred to in the preceding description and will not be repeated herein.

In some examples, the 3D printed object 200 comprises one or more of a vertical sidewall 231, an inwardly sloping sidewall 233, and an overhanging sidewall 232. The vertical sidewall 231 is a part of the printing body 210 having a vertical side. The inwardly sloping sidewall 233 is a part of the printing body 210 having a gradually inwardly sloping side. The overhanging sidewall 232 is a part of the printing body 210 having a gradually outwardly sloping side. In practical applications, various parts of the 3D printed object 200 may be generally categorized into the above three parts. For the convenience of illustration, this example is illustrated that the printing body 210 comprises the vertical sidewall 231, the inwardly sloping sidewall 233, and the overhanging sidewall 232. However, in practical applications, the specific shapes of the sidewalls of the 3D printed object 200 may be set arbitrarily and are not limited herein.

Specifically, sides of a plurality of the base printing layers 211 corresponding to the vertical sidewall 231 away from the printing body 210 are flush, thereby forming a vertical sidewall, and ensuring the appearance shape of the 3D printed object 200.

In a direction from a bottom surface 241 to a top surface 242 of the 3D printed object 200, edges, at a side away from the printing body 210, of a plurality of the base printing layers 211 corresponding to the inwardly sloping sidewall 233 are shortened layer by layer, and edges, on the side away from the printing body 210, of a plurality of the color layers 221 corresponding to the inwardly sloping sidewall 233 are inclined layer by layer to a side close to the printing body 210.

In the direction from the bottom surface 241 to the top surface 242 of the 3D printed object 200, edges, on the side away from the printing body 210, of a plurality of the base printing layers 211 corresponding to the overhanging sidewall 232 are lengthened layer by layer, and edges, on the side away from the printing body 210, of a plurality of the color layers 221 corresponding to the overhanging sidewall 232 are inclined layer by layer to the side away from the printing body 210.

The 3D printed object 200 having multiple sidewall shapes may be formed by assembling and combining one or more of the vertical sidewall 231, the inwardly sloping sidewall 233, and the overhanging sidewall 232. For illustrative purposes, in this example, sidewalls of the 3D printed object 200 have the same structure on the same horizontal plane. However, in practice, structures of the sidewalls on the same horizontal plane are arbitrarily set based on actual needs, and are not limited herein.

In some examples, each of a color layer 221 corresponding to the vertical sidewall 231 and a color layer 221 corresponding to the inwardly sloping sidewall 233 may comprise a fixed color layer 223 and an outer wall color layer 222. The fixed color layer 223 and the outer wall color layer 222 are stacked. A side of the fixed color layer 223 that is close to the printing body 210 protrudes beyond a side of the corresponding outer wall color layer 222 that is close to the printing body 210.

A part of the fixed color layer 223, which is close to the printing body 210 and protrudes beyond the corresponding outer wall color layer 222, may be inserted into the printing body 210, ensuring that the fixed color layer 223 is inserted between every two adjacent base printing layers 211 (e.g., the fixed color layer 223 adheres to the two adjacent base printing layers 211).

By inserting the fixed color layer 223 between two adjacent base printing layers 211, friction areas between the fixed color layer 223 and the base printing layers 211 can be increased, and binding force between the fixed color layer 223 and the base printing layers 211 can be increased. The fixed color layer 223 and the outer wall color layer 222 are stacked on and adhere to each other and are made of the same material, which enhances the binding force between the fixed color layer 223 and the base printing layers 211, thereby enhancing the binding force between the entire color shell 220 and the base printing layer 211, as well as enhancing the structural stability and reliability between the color shell 220 and the printing body 210.

In a specific application scenario, a range of a preset distance between an outermost trajectory and a corresponding innermost trajectory of the outer wall color layer 222 may be determined regarding the effect of color reproduction based on experimental measurements. Specifically, the preset distance may be in a range of 0.2 mm to 0.5 mm, such as 0.2 mm, 0.3 mm, 0.4 mm, or 0.5 mm. The outer wall color layer 222 within this preset distance provides sufficient color reproduction while avoiding a distance that is too large to increase printing consumption. A distance between the outermost trajectory and a corresponding innermost trajectory of the fixed color layer 223 may be in a range of 0.6 mm to 1.5 mm, such as 0.6 mm, 0.8 mm, 1.0 mm, 1.1 mm, 1.2 mm, or 1.5 mm. The fixed color layer 223 within this preset distance can provide sufficient interlayer binding between the color shell 220 and the base printing layers 211, and also prevent any negative impact on the binding force between adjacent base printing layers 211.

In some examples, a base printing layer 211 comprises a plurality of outer printing layers 212 and an inner printing layer 213. Each outer printing layer 212 may have a thickness that is less than a thickness of the inner printing layer 213.

By making the thickness of each outer printing layer 212 less than the thickness of the inner printing layer 213, the precision as well as the resolution of the outer printing layers 212 can be increased, thereby improving the surface precision of the printing body 210 as well as of the 3D printed object 200.

In a specific application scenario, the outer printing layers 212 of the same layer may include two circles of the outer printing layers 212, wherein the outer printing layers 212 on an inner circle connects the outer printing layers 212 on an outer circle with the inner printing layer 213 to improve the binding force therebetween, thereby improving the structural stability and reliability of the printing body 210.

In some examples, a thickness of an outer printing layer 212 may be equal to that of the inner printing layer 213, ensuring the printing efficiency of the base printing layer 211 to a certain extent.

In some examples, the outer printing layers 212 of a plurality of the base printing layers 211 corresponding to the overhanging sidewall 232 are outer wall transmissive printing layers 215. A color layer 221 corresponding to the overhanging sidewall 232 includes a fixed color layer 223. An outer wall transmissive printing layer 215 extends toward a side away from the printing body 210 until it passes through the fixed color layer 223 for exposure. The fixed color layer 223 is inserted between every two adjacent outer wall transmissive printing layers 215.

Because the overhanging sidewall 232 is inclined outward, there is no foundational support for the stacked printing of the color layers 221. In this example, the outer printing layers 212 of the base printing layers 211 corresponding to the overhanging sidewall 232 are configured as the outer wall transmissive printing layers 215 which extend outward for exposure, thus presenting the appearance shape of this part of the 3D printed object 200. By inserting the fixed color layer 223 between the adjacent outer wall transmissive printing layers 215 and utilizing the transparent nature of the outer wall transmissive printing layers 215, the color of the fixed color layer 223 is transmitted, thereby ensuring the appearance color of this part of the 3D printed object 200.

In a specific application scenario, a thickness of an outer wall transmissive printing layer 215 may be less than that of an outer printing layer 212 corresponding to the vertical sidewall 231 or the inwardly sloping sidewall 233, thereby improving the shape precision and resolution of the appearance of the overhanging sidewall 232 by a plurality of the thin outer wall transmissive printing layers 215. The thickness of the outer wall transmissive printing layer 215 may be less than 0.05 mm, such as 0.01 mm, 0.02 mm, 0.03 mm, 0.04 mm, or 0.05 mm. The thickness of the outer printing layer 212 corresponding to the vertical sidewall 231 or inwardly sloping sidewall 233 may be in a range of 0.15 mm to 0.25 mm, such as 0.15 mm, 0.18 mm, 0.20 mm, 0.23 mm, or 0.25 mm. The transparency of the outer wall transmissive printing layer 215 may be above 70%, such as 70%, 75%, 80%, 85%, 90%, or 95%, to effectively transmit the color of the fixed color layer 223 and ensure the appearance color of this part of the 3D printed object 200.

In some examples, the color layer 221 further comprises an end surface color layer 224 and the 3D printed object 200 further includes an end surface transmissive printing layer 214. The printing body 210 comprises at least one end surface (not shown in the drawings), the end surface color layer 224 adheres to the entire end surface, and the end surface transmissive printing layer 214 adheres to the side of the end surface color layer 224 that is away from the printing body 210. The end surface may include a bottom surface 241, a bridging bottom surface (not shown), and a top surface 242. The end surface transmissive printing layer 214 may comprise a bottom surface printing layer and a top surface printing layer.

The 3D printed object 200 is provided with the bottom surface 241, and may be provided with the top surface 242. For example, if the 3D printed object 200 is a pyramid, it has only one bottom surface 241 and no top surface 242. If the 3D printed object 200 is a cylinder, it has both a bottom surface 241 as well as a top surface 242. There are one or more bottom surfaces 241 and/or the top surfaces 242 of the same 3D printed object 200. For example, when the 3D printed object 200 is a cylinder, it has one bottom surface 241 and one top surface 242. When the 3D printed object 200 is a four-legged table, it may include four table legs as well as a tabletop, for a total of five bridging bottom surfaces. If the 3D printed object 200 is a fence, it may include a plurality of bridging bottom surfaces as well as a plurality of top surfaces 242. These examples are not limiting.

In order to ensure the color display and the structural stability of the bottom surface 241 and the top surface 242, the end surface color layers 221 are provided at the bottom surface 241 and the top surface 242, respectively, and cover the entire end surfaces, and the end surface transmissive printing layer 214 is provided on a side of each end surface color layer 224 away from the printing body 210 so that the colors of the bottom surface 241 and the top surface 242 are displayed by the colors of the end surface color layer 224 through the end surface transmissive printing layer 214. By covering the outer side of the end surface color layer 224 with the end surface transmissive printing layer 214, the end surface color layer 224 can be prevented from exposure, thereby enhancing the structural stability of the end surface color layer 224.

Transparency of the end surface transmissive printing layer 214 may be the same or different as that of the outer wall transmissive printing layer 215. To ensure the transparency, the thickness of the end surface transmissive printing layer 214 may be less than that of the base printing layer 211, and may be the same as that of the outer wall transmissive printing layer 215. In a specific application scenario, the top surface 242 may be only provided with the end surface color layer 224 to ensure the appearance color, without the end surface transmissive printing layer 214.

With the above-described structure, the 3D printed object in this example is provided with the color shell on the exposed side of the printing body, thereby enhancing the shape precision of the outermost side of the 3D printed object, increasing the resolution of the outer wall color layer, and improving the appearance precision of the 3D printed object by utilizing a more refined outer wall color layer. Moreover, a more delicate and realistic color expression can be achieved using the high-precision outer wall color layers, enhancing the color presentation precision and color reproduction of the 3D printed object. In this example, a fixed color layer is inserted between every two adjacent base printing layers. By enhancing the binding force between the fixed color layer and the base printing layers, the overall binding force between the color shell and the base printing layers is improved, thereby increasing the structural stability and reliability between the color shell and the printing body. The outer printing layers of a plurality of the base printing layers corresponding to the overhanging sidewall are configured as the outer wall transmissive printing layers 215, which extend outward for exposure, thus presenting the appearance shape of this part of the 3D printed object. By inserting the fixed color layer between the adjacent outer wall transmissive printing layers and utilizing the transparent nature of the outer wall transmissive printing layers, the color of the fixed color layer is transmitted, thereby ensuring the appearance color of this part of the 3D printed object. In order to ensure the color of the end surfaces of the 3D printed object, by providing the end surface color layers at the end surfaces, which cover the entire end surfaces, respectively, and providing the end surface transmissive printing layer at a side of each end surface color layer away from the printing body, the colors of the end surfaces are displayed by the colors of the end surface color layer through the end surface transmissive printing layer. By covering the outer side of the end surface color layer with the end surface transmissive printing layer, the end surface color layer can be prevented from exposure, thereby enhancing the structural stability of the end surface color layer.

The above description is only examples of the present disclosure, and is not intended to limit the scope of the present disclosure. Any equivalent structure or equivalent process transformations utilizing the implementations of specification and the accompanying drawings, or the implementations directly or indirectly applied in other related technical fields, are included in the scope of the present disclosure.

What is claimed is:

1. A method of printing an object, comprising:
determining, by a computing device, a printing trajectory of a current base layer;
determining, based on the printing trajectory of the current base layer, whether an edge of the current base layer protrudes beyond an edge of a previous base layer; and
based on determining that the edge of the current base layer does not protrude beyond the edge of the previous base layer:
printing a plurality of current outer wall color layers in an edge region of a surface of the object; and
printing the current base layer in a middle region of the surface of the object to obtain an additively printed object, wherein a thickness of the plurality of current outer wall color layers equals a thickness of the current base layer, and the edge region adheres to the middle region.

2. The method according to claim 1, wherein the printing the plurality of current outer wall color layers and printing the current base layer comprises:
printing a first subset of the plurality of current outer wall color layers in the edge region of the surface of the object until a thickness of the first subset of the plurality of current outer wall color layers reaches half of the thickness of the current base layer; and
printing a second subset of the plurality of current outer wall color layers on a side of the printed first subset of the plurality of current outer wall color layers until a thickness of the plurality of current outer wall color layers reaches the thickness of the current base layer.

3. The method according to claim 1, wherein the printing the plurality of current outer wall color layers and printing the current base layer comprises:
printing the current base layer by adhering the current base layer to the plurality of the current outer wall color layers in the middle region of the surface of the object to obtain an additively printed object, wherein sides of the plurality of current outer wall color layers close to the current base layer are flush.

4. The method according to claim 1, wherein the printing the plurality of the current outer wall color layers and printing the current base layer comprises:
printing a current fixed color layer in an edge region of one of the plurality of current outer wall color layers, wherein a side of the current fixed color layer close to the middle region protrudes beyond a side of the one of the plurality of current outer wall color layers close to the middle region.

5. The method according to claim 4, further comprising:
based on determining that the edge of the current base layer protrudes beyond the edge of the previous base layer, printing a current outer wall transmissive layer and the current fixed color layer alternately and stackedly in the edge region of the surface of the object.

6. The method according to claim 1, further comprising:
obtaining a printing trajectory of a bottom surface layer;
printing the bottom surface layer based on the printing trajectory of the bottom surface layer; and
printing a first end surface color layer on a side of the bottom surface layer.

7. The method according to claim 6, further comprising:
printing a second end surface color layer on a side of the object away from the bottom surface layer.

8. The method according to claim 1, wherein the determining the printing trajectory of the current base layer comprises:
obtaining an overall shape of a 3D printed object;
slicing the overall shape based on thicknesses of base layers to obtain printing trajectories of a plurality of layer structures of the 3D printed object;
retracting the printing trajectory of each of the layer structures by a preset distance; and
obtaining a printing trajectory of each of the base layers corresponding to the layer structures, and the method further comprises obtaining a printing trajectory of each of color layers based on the retracted printing trajectory.

9. The method according to claim 1, wherein the printing the plurality of current outer wall color layers and printing the current base layer comprises:
printing the plurality of current outer wall color layers in the edge region of the surface of the object using photocuring ink, and printing the current base layer in the middle region of the surface of the object using fused deposition modeling (FDM).

10. The method according to claim 1, further comprising:
repeating the determining and the printing steps until a 3D object is completed.

11. A three-dimensional (3D) printed object, comprising:
a body comprising a plurality of base layers; and
a color shell wrapping around an exposed side of the body and comprising a plurality of outer wall color layers, wherein:
the plurality of outer wall color layers and the plurality of base layers are stacked on a same horizontal plane, and
a thickness of each one of the outer wall color layers is less than a thickness of one of the plurality of the base layers.

12. The 3D printed object according to claim 11, further comprising one or more of a vertical sidewall, an inwardly sloping sidewall, and an overhanging sidewall, wherein:
sides of the plurality of base layers corresponding to the vertical sidewall are flush, and
sides of the plurality of outer wall color layers corresponding to the vertical sidewall are flush.

13. The 3D printed object according to claim 12, wherein:
in a direction from a bottom surface to a top surface of the 3D printed object, edges, on a side of the plurality of base layers corresponding to the inwardly sloping sidewall are shortened layer by layer, and edges, on a side, of the plurality of outer wall color layers corresponding to the inwardly sloping sidewall are inclined layer by layer to a side close to the body; and
in a direction from the bottom surface to the top surface of the 3D printed object, edges, on a side of the plurality of base layers corresponding to the overhanging sidewall are lengthened layer by layer, and edges, on a side of the plurality of outer wall color layers corresponding to the overhanging sidewall are inclined layer by layer to the side away from the body.

14. The 3D printed object according to claim 12, further comprising a plurality of fixed color layers, wherein:
the plurality of fixed color layers and the plurality of outer wall color layers are stacked;
a side of each of the plurality of fixed color layers close to the body protrudes beyond a side of a corresponding outer wall color layers close to the body; and
a part of each of the fixed color layers, which is close to the body and protrudes beyond a corresponding outer wall color layers, is inserted into the body to adhere to two adjacent base layers.

15. The 3D printed object according to claim 14, wherein each of the plurality of base layers comprises a plurality of outer layers and an inner layer, and a thickness of each of the plurality of outer layers is less than a thickness of the inner layer.

16. The 3D printed object according to claim 15, wherein:
outer layers of the plurality of base layers corresponding to the overhanging sidewall are outer wall transmissive layers;
the outer wall transmissive layers extend toward a side away from the body until being exposed; and
each of the plurality of fixed color layers is interposed between every two adjacent outer wall transmissive layers.

17. The 3D printed object according to claim 11, further comprising:
an end surface color layer and an end surface transmissive layer, wherein:
the body comprises at least one end surface, and the end surface color layer adheres to the end surface,
the end surface comprises a bottom surface, a bridging bottom surface, and a top surface, and
if the end surface is the bottom surface or the bridging bottom surface, the end surface transmissive layer adheres to a side of the end surface color layer away from the body.

18. A method of printing an object, comprising:
determining, based on a printing trajectory of a current base layer, whether an edge of the current base layer protrudes beyond an edge of a previous base layer;
based on determining that the edge of the current base layer does not protrude beyond the edge of the previous base layer, printing a layer comprising:
the current base layer on top of the previous base layer; and
a plurality of current outer wall color layers on sides of the current base layer, wherein a thickness of the plurality of current outer wall color layers equals a thickness of the current base layer.

19. The method according to claim 18, wherein the printing the current base layer comprises printing the current base layer by adhering the current base layer to the plurality of the current outer wall color layers in a middle region of a surface of the object to obtain an additively printed object, wherein sides of the plurality of current outer wall color layers close to the current base layer are flush.

20. The method according to claim 18, wherein the determining the printing trajectory of the current base layer comprises:
obtaining an overall shape of a 3D printed object;
slicing the overall shape based on thicknesses of base layers to obtain printing trajectories of a plurality of layer structures of the 3D printed object;
retracting the printing trajectory of each of the layer structures by a preset distance; and
obtaining a printing trajectory of each of the base layers corresponding to the layer structures, and the method further comprises obtaining a printing trajectory of each of color layers based on the retracted printing trajectory.
